(19) United States
(12) Patent Application Publication
(10) Pub. No.: US 2007/0271220 A1
(43) Pub. Date: Nov. 22, 2007

(54) SYSTEM, METHOD AND APPARATUS FOR FILTERING WEB CONTENT

(75) Inventor: Stephen Harold Carter, Parrish, FL (US)

Correspondence Address: LARSON AND LARSON, 11199 69TH STREET NORTH, LARGO, FL, 33773, US

(73) Assignee: CHBAG, INC., Parrish, FL (US)

(21) Appl. No.: 11/671,569

(22) Filed: Feb. 6, 2007

Related U.S. Application Data
(60) Provisional application No. 60/801,615, filed on May 19, 2006.

(51) Int. Cl. G06F 17/30

(52) U.S. Cl. 707/2

(57) ABSTRACT

An application for a pre-configured Internet protection device includes a processor with a first network interface for connecting to a World-Wide-Web or other external network coupled to the processor and a second network interface for connecting to at least one terminal device also coupled to the processor. Software for preventing access from the terminal device to at least one web service executes on the processor, whereas the software is pre-configured with lists, algorithms, processes and methods for protecting a pre-determined class of user.

### CROSS-REFERENCE TO RELATED APPLICATIONS

This application is a continuation of prior U.S. provisional application No. 60/801,615, filed May 19, 2006, which is hereby incorporated by reference.

### BACKGROUND OF THE INVENTION

1. Field of the Invention

This invention relates to the field of content protection and more particularly to a device for protecting certain classes of users from objectionable content on the Internet.

2. Description of the Related Art

The Internet is a global network of computers linked together so that the computers can communicate seamlessly with one another. There are many excellent uses for the World Wide Web including education, commerce and entertainment. Internet users access web servers where such content is stored in order to download and display this content. Once a server has been connected to the Internet, its content can be displayed by virtually anyone having access to the Internet. Each day, millions of content providers present content such as educational content through the World Wide Web to many millions of users.

Although much of the content provided on the World Wide Web is of general nature, some content (e.g., pornography) may be objectionable to certain classes of users. Some providers limit their web sites to certain ratings of content, such as G rated content suitable for most consumers. Other content providers provide more graphic content that is rated R or X rated. This content might be suitable for an adult consumer, but be objectionable for a child or a young adult due to pornographic content, violent content or other reasons. Often, a parent or guardian is concerned about the type of content a child or young adult can access, either inadvertently or deliberate. Unfortunately, the parent can't always watch over the child to make sure the child doesn't access content that is inappropriate, etc.

Some web sites have assigned ratings to their content so those visiting will not be surprised. Such a rating requires Internet servers to be voluntarily rated by their administrator. Because of the free nature of the Internet, this type of voluntary rating scheme is unlikely to be very attractive to parents for preventing access to certain sites by their children; for example those containing pornography.

An alternative to this rating system is a database containing the uniform resource locator (URL—an address where a content page is stored) of sites to be blocked. These databases are sometimes integrated into computer systems and Internet firewalls so that a person wishing access to the Internet has their URL request matched against the database of blocked sites. In some implementations, the user cannot access a URL if it is found in the database (e.g., blacklisted). In other implementations, the user can access a URL only if it is found in the database (e.g., whitelisted). One such system is described in U.S. Pat. No. 5,678,041 to Baker et al, which is hereby incorporated by reference.

Public access computers, such as those found in public libraries or school libraries have similar problems. These public access computers are often used in open areas, in plain sight of all, including little children. In such situations, even an adult who might not find it objectionable to visit adult web sites, could subject children within range of the public access computer to the visual content of such sites.

Many solutions to this problem have been implemented in the past. Most solutions include software running on the user's computer for restricting access from specific web sites or types of content. One such solution is described in U.S. Pat. No. 6,928,455 to Dougu, et al. In it, a method for controlling access to information through the Internet includes providing a database having a list of accessible Internet sites and a database having a list of prohibited Internet sites. Another database has a list of forbidden keywords. Access to Internet sites listed in the first database is allowed while access to Internet sites listed in the second database or Internet content containing keywords in the third database is prohibited. There are many ways to administer the described system including modifying the databases, preventing certain access during certain time periods, etc. This administration creates several problems including creating an opportunity for a creative user to modify the databases and bypass the security. Another problem is complexity—the more administration required the greater chances an administrator (parent) will make an error or get frustrated and not provide the desired protection.

Various software products have appeared that run on the user's computer and are intended to stop a child or young adult from accessing illicit material. One such example is “Net Nanny” from LookSmart, Ltd. Again, this product runs on the target computer and, having lots of time, a child or young adult may be able to figure out the file structure of the software or, a parent that is not very computer literate may not correctly administer this product, leaving some illicit content accessible to their children.

These solutions make some improvements but present complex and difficult setup and configuration hurdles for a typical parent, often resulting in little or inadequate protection. Furthermore, the child being protected can often figure out how to bypass the software designed to protect them. These issues often result in a false sense of security, in that the child can access content that is not suitable for their age range without detection.

Many access points and routers include an Internet firewall. The Internet firewall protects computers on the data terminal side of the access point or router from attempted attacks from the Internet side. Some firewalls restrict access to content from all computers connected through the firewall device, but require high degrees of knowledge and understanding in order to set-up and configure. For example, just to access the device, the parent needs to enter the IP address of the device into their browser, then login using a username and password provided in the user manual for the device. Some routers or access points have some form of parental control, but the prior art does not include a router or access point that has a pre-configured parental control geared to a specific class of user such as a user of a predetermined age range or a user covered by a predetermined rating category (e.g., PG-13). By not being pre-configured, the prior art presents usage difficulties for the average parent including setup, administration, controlling objectionable content, updating, reporting, etc.

The aforementioned solutions have proven to be too difficult to install and maintain for an average computer user and often ineffective at protecting children and others from inappropriate content. What is needed is an Internet Protection device that is easy for a parent to install and maintain while being effective at preventing computing systems and devices from accessing certain web content and services, including but not limited to web pages, instant messaging, email and peer-to-peer networking.

### SUMMARY OF THE INVENTION

One objective of the present invention is to reduce the amount of technical expertise required to setup content filtering/parental controls in a content protection device.

Another objective of the present invention is to provide a content protection device that eliminates the need to install software on a user's terminal device.

Another objective of the present invention is to provide a content protection device that is not easily circumvented.

In one embodiment, an Internet protection device is disclosed including a processor with a first network interface for connecting to a network (e.g., the World-Wide-Web) coupled to it and a second network interface for connecting to at least one terminal also coupled to the processor. Pre-configured software for selectively preventing access from the terminal to at least one web service executes on the processor.

In another embodiment, an Internet protection device is disclosed including a processor and a device for connecting to a network (e.g., the World-Wide-Web) which is coupled to a first network interface which is, in turn, coupled to the processor. A device for connecting to a terminal is coupled to a second network interface that is also coupled to the processor. Pre-configured software for selectively preventing access from the personal computer to at least one web service executes on the processor.

In another embodiment, a method for protecting a class of users of a terminal device from undesirable Internet content is disclosed including providing an Internet protection device with a processor that has circuitry for connecting to the Internet through a modem or other network attachment arrangement coupled to the processor and circuitry for connecting to a terminal device, also coupled to the processor. The Internet protection device has software for preventing access from the terminal device to at least one web site containing undesirable content that executes on the processor. In some embodiments, a pre-configured authorization list has entries that indicate a content type of at least one internet page. After a user enters a unified resource locator of a target internet page, the unified resource locator is looked up in the pre-configured authorization list by the software and, if the unified resource locator is listed as having the undesirable internet content in the pre-configured authorization list, the software prevents access to the target internet page. If the unified resource locator is listed as having desirable Internet content in the pre-configured authorization list, the software allows access to the target Internet page.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a network of all embodiment of the present invention.

FIG. 2 illustrates a first typical computer configuration of the prior art.

FIG. 3 illustrates a second typical computer configuration of the prior art.

FIG. 4 illustrates a first typical computer configuration of the present invention.

FIG. 5 illustrates a second typical computer configuration of the present invention.

FIG. 6 illustrates a third typical computer configuration of the present invention.

FIG. 7 illustrates a fourth typical computer configuration of the present invention.

FIG. 8 illustrates a schematic view of a computer of the prior art.

FIG. 9 illustrates a schematic view of a computer of the present invention.

FIG. 10 illustrates a flowchart of unrestricted browsing of the prior art.

FIG. 11 illustrates a flowchart of protected browsing of a first embodiment of the present invention using a whitelist.

FIG. 12 illustrates a flowchart of protected browsing of a first embodiment of the present invention using a blacklist.

FIG. 13 illustrates a flowchart of protected browsing of a first embodiment of the present invention using a content keyword blacklist.

FIGS. 14, 14A and 14B illustrate a continuation of FIGS. 11, 12 and 13, a flowchart of protected browsing of a first embodiment of the present invention.

FIG. 15 illustrates a typical hardware configuration of a Kidzguard of the present invention.

FIG. 16 illustrates a schematic view of a first embodiment of the Kidzguard of the present invention.

FIG. 17 illustrates a schematic view of a second embodiment of the Kidzguard of the present invention.

FIG. 18 illustrates a flowchart of a first method of configuring of all embodiments of the present invention.

FIG. 19 illustrates a flowchart of a second method of configuring of all embodiments of the present invention.

FIG. 20 illustrates a schematic view of a third embodiment of the Kidzguard of the present invention.

FIG. 21 illustrates a flowchart of protected browsing of a third embodiment of the present invention using remote content checking.

FIG. 22 illustrates a flowchart of protected browsing of a fourth embodiment of the present invention including analysis of content.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. Throughout this description, the term Unified Resource Locator (URL) refers to the method of addressing an Internet web site such as http://www.google.com. It is envisioned that this method may progress and adapt to future needs and the present invention works equally well with these adaptations. An Internet Protocol Address (IP Address) is typically in the form of x.x.x.x, where x is a number between 0 and 255 (or 0 and FF hexadecimal). It is also envisioned that IP Addresses may evolve to accommodate a greater address range, and the present invention works equally well with this evolution. Throughout this description, the network of choice is referred to as the Internet, or World Wide Web. This terminology is intended to include other networks with other names as the technology evolves and such other networks are envisioned to use similar or different addressing schemes to URLs. Also, throughout this description, the term, “terminal” or “terminal device” is used as a generic term for any user device that is network-enabled, including, but not limited to, personal computers, televisions, personal video recorders, personal digital assistants and phones. Also, throughout this description, the term, “modem” is used as a generic term for any device that connects a user to a wide-area network, including, but not limited to, cable (e.g., DOCSIS), digital subscribe lines (DSL), high-speed carriers (e.g., T1, T3) and Fiber (e.g., Optical Network Terminals). Throughout this description the term pre-configured is used as a generic term to describe software or a hardware device that does not require configuration or setting changes by the end user to serve its intended function. A pre-configured hardware device would function as advertised out of the box, requiring only physical installation.

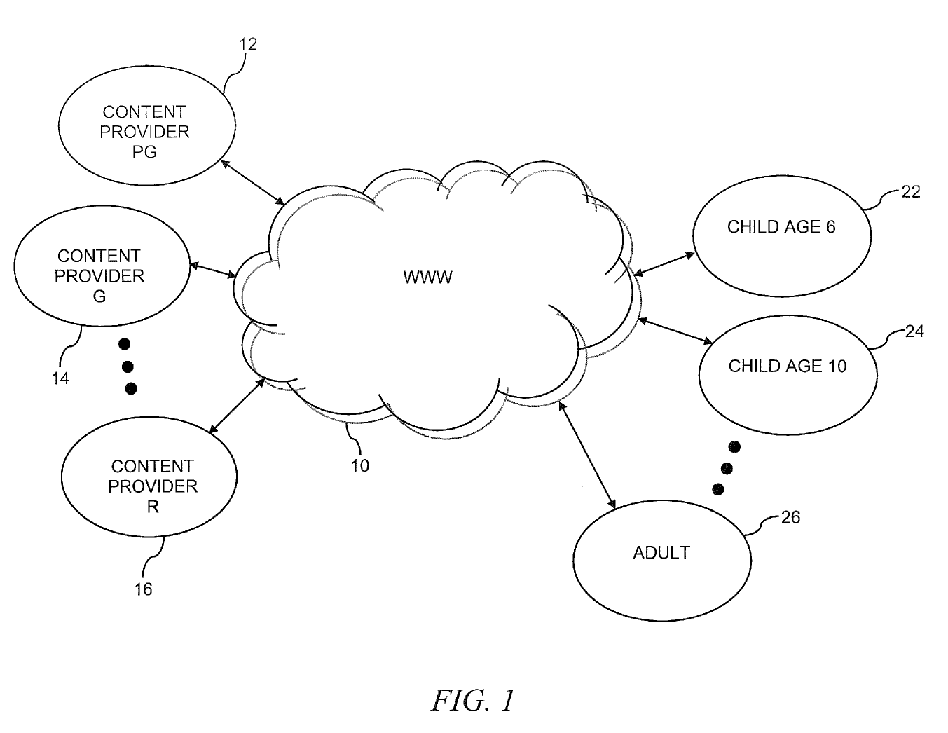

Referring to FIG. 1, a schematic view of a network of the prior art and of the present invention is shown. The World Wide Web 10 has had a vast impact upon many individuals and companies throughout the world. There are many excellent uses for the World Wide Web 10 including education, commerce and entertainment. In general, the World Wide Web 10 includes many content providers 12/14/16 that provide content such as educational content through the World Wide Web 10 to typical users 22/24/26.

Although much of the content provided on the World Wide Web 10 is of general nature, some content may be objectionable to certain classes of users. For example, a content provider 14 provides G rated content suitable for most consumers 22/24/26. On the other hand, a content provider 16 provides R rated content that might be suitable for an adult consumer 26, but be objectionable for a ten-year-old child 24 or a six-year-old child 22.

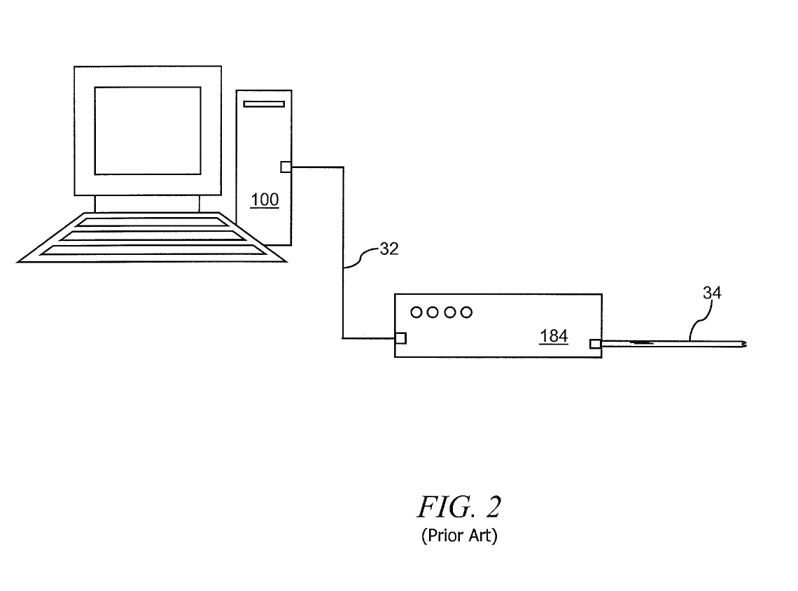

Referring to FIG. 2, a first typical computer configuration of the prior art is shown. In this simplified configuration, a user's computer 100 is connected to a Digital Subscriber Line (DSL) modem 184, preferably by an Ethernet cable 32. The DSL Modem 184 is typically connected to a phone line 34. In this example, a person using the computer 100 is not restricted from accessing any particular web site available on the World Wide Web 10. In cases where the person is a child, the child may have access to certain, objectionable material. Prior solutions such as those described in the background section include software installed on the child's computer 100. Unfortunately, many parents don't know how to install such software. Additionally, the parents don't know how to administer and protect the software from an ingenious child with lots of time on his or her hands. Often, a child learns more than their parents about the parental control software and knows how to disable it or work around it without the parent having the slightest suspicion.

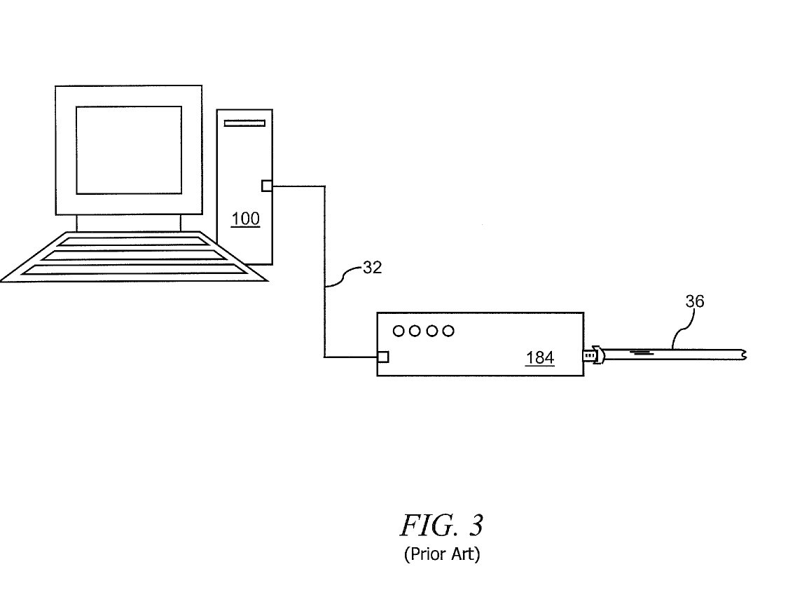

Referring to FIG. 3, a second typical computer configuration of the prior art is shown. In this simplified configuration, a user's computer 100 is connected to a Cable modem 184 instead of a DSL modem 184 as in FIG. 2, preferably by an Ethernet cable 32. The cable modem 184 is then connected to a cable company access cable 36. In this example, a person using the computer 100 is not restricted from accessing any particular web site available on the World Wide Web 10. There are many other broadband access methods possible.

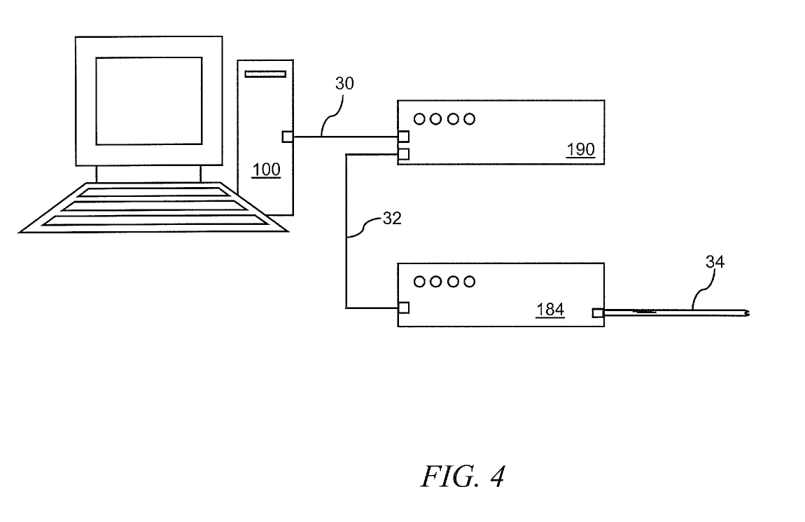

Referring to FIG. 4, a first typical computer configuration of the present invention is shown. This exemplary configuration is similar to the prior art, in that, there is a DSL modem 184 that connects to a phone line 34, but in this example of the present invention, the unprotected Ethernet data cable 32 does not pass directly to the protected computer 100. Instead, it is connected to a kidzguard 190 of the present invention, whereby parental protection is provided and a protected Ethernet connection 30 connects the kidzguard 190 to the protected computer 100. The kidzguard device is a hardware device that is inserted between a child's or young adult's computer and a broadband Internet connection. The kidzguard device helps protect the child or young adult from undesirable Internet content. By using a dedicated kidzguard device 190, several features are possible that were not possible in the prior art. These features include zero administration, in that, by inserting a certain version of the kidzguard device 190 into an existing configuration, a certain level of protection is provided without entering any information or performing any configuration. For example, if a kidzguard device 190 designated to protect content suitable for children up to age eight, then, once physically connected, the child is protected from content unsuitable for their age range. Once that child reaches age eight or so, a kidzguard 190 for ages 9-12 is inserted in place of the previous kidzguard 190 and protection continues for the older child. The parent does nothing more difficult than what would be required in installing a modular telephone answering machine. Furthermore, the only type of connections the parent needs to make is RJ-45 connections, which physically operate identically to the RJ-11 connections of the familiar telephone system.

Of course, for the more advanced parent, the kidzguard 190 can, in some instances, be administered, but no administration is required to obtain the basic level of protection. Because children develop as they age, it is preferred that the kidzguard devices are made available for protecting certain ranges of children/young adults. Although the various ages and developmental needs of children and young adults vary, for practical reasons it is preferred that a different kidzguard device 190 be configured for classes of children or young adults. For example, classes such as ages 0-8, 9-12 and 13-adult. Alternately, in another embodiment, rating systems are used such as those defined by the Motion Picture Association of America (MPAA) such as G, PG, PG13, R, etc. In another embodiment, a kidzguard device 190 is configured to block certain categories of content such as pornography, violence or foul language or a combination of such categories. Such a kidzguard device 190 may be useful for a small company. In yet another embodiment, the kidzguard device 190 restricts certain Internet domains or protects from URLs with specific words. Examples of these are www.get-porn.com or www.anysite.xxx. In some embodiments, the kidzguard device 190 is configured to protect based upon religion or other criteria.

The kidzguard device 190 of the present invention is excellent at protecting a user of a connected computer from accessing content that is deemed inappropriate. In order to be effective, the kidzguard device 190 must be inserted in the communications path between the protected computer(s) and a broadband connection (e.g., cable, DSL, T1, T3). It is possible that an energetic child may figure out that by bypassing the kidzguard device 190, they can access content that is normally blocked. To prevent such or provide detection when the kidzguard device 190 is bypassed, it can be made difficult to bypass the kidzguard device or it can be made obvious when the kidzguard device is bypassed. For example, cable lengths are selected to make it impossible for the child/young adult to connect their computer directly to the broadband modem. Alternately, the RJ-45 release pin is trimmed so that the RJ-45 plug cannot easily be removed from the RJ-45 connector. Another alternative is to use security tape over one or more of the RJ-45 connections so that removal of the protected RJ-45 plug will be obvious to the parent. In another embodiment, a locking door is provided (not shown) that closes after plugging the RJ-45 connectors into their jacks. The locking door has openings large enough for the Ethernet cables, but not large enough for the RJ45 connectors to pass. Thereby, the child or young adult is not able to remove the RJ-45 plugs from the RJ-45 jacks. The lock is either a key-lock or uses a special fastener such as a security screw as known in the industry.

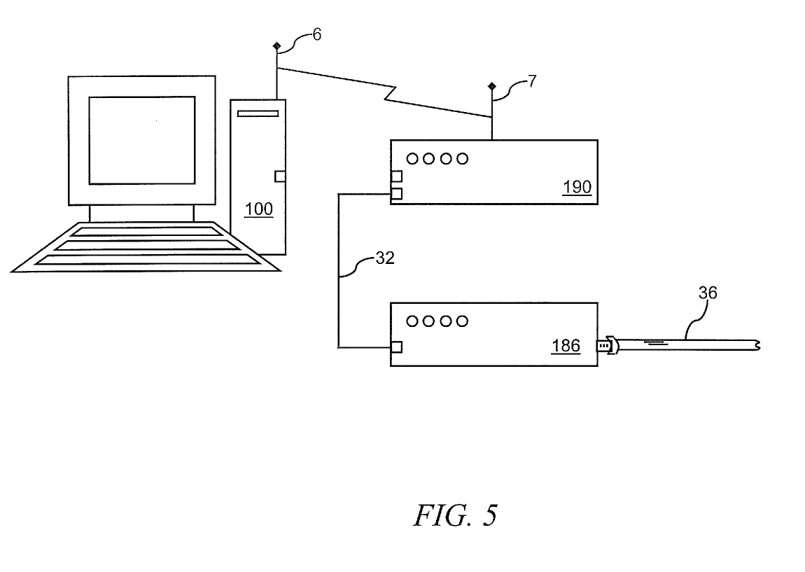

Referring to FIG. 5, a second typical computer configuration of the present invention is shown. This exemplary configuration is similar to the configuration shown in FIG. 4, except, the modem 184 is a cable modem 186 connected to a broadband cable connection 36 instead of a phone line 34 and the child's computer 100 is connected by a wireless link 6/7. The unprotected Ethernet data cable 32 is connected to a kidzguard 190 of the present invention, whereby parental protection is provided and a protected wireless connection between an antenna 6 on the kidzguard device 190 and an antenna on the child's computer 7 connects the kidzguard 190 to the protected computer 100.

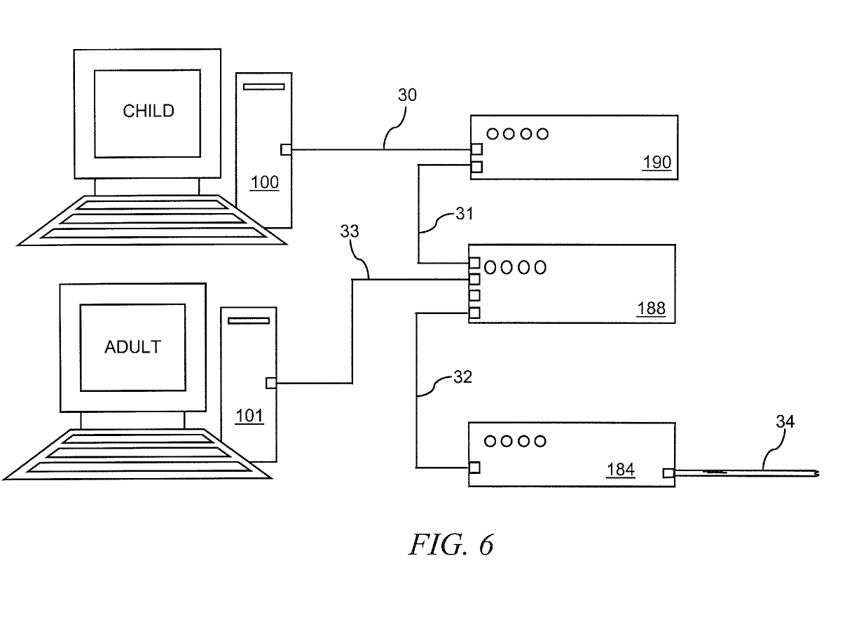

Referring to FIG. 6, a third typical computer configuration of the present invention is shown. In this configuration, the unprotected Ethernet cable 32 connects first to an Ethernet hub 188, then to both an unprotected computer 101 through a second unprotected Ethernet cable 33 and to a kidzguard device 190 through a third unprotected Ethernet cable 31. The child's or young adult's computer 100 is connected through the protected Ethernet cable 30. In this configuration, the adult or parent's computer 101 has full access to the Internet while the child's or young adult's computer 100 has restricted access determined by the configuration of their associated kidzguard 190. It is envisioned that, additional kidzguard devices 190 can be connected to other Ethernet ports on the Ethernet hub 188, perhaps with protection for different age ranges, etc.

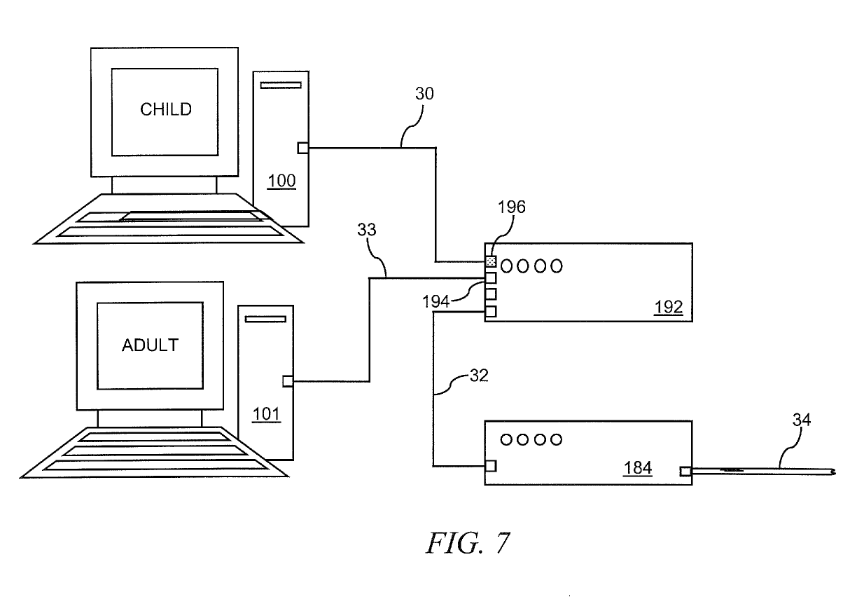

Referring to FIG. 7, a fourth typical computer configuration of the present invention is shown. In this configuration, the unprotected Ethernet cable 32 connects first to a kidzguard device 192 with an integrated Ethernet hub. The kidzguard device 192 has one or more protected Ethernet ports 196 to which the child's or young adult's computer 100 is connected through the protected Ethernet cable 30. In some embodiments, the kidzguard device 192 also has one or more unprotected Ethernet ports 194 to which one or more unprotected Ethernet cables 33 are connected. The adult's or parent's computer 101 is connected to the unprotected Ethernet cables 33 and, therefore, has full access to the Internet while the child's or young adult's computer 100 has restricted access determined by the configuration of their associated kidzguard 190. It is envisioned that, additional kidzguard devices 190 can be connected to unrestricted Ethernet ports 194 on the Ethernet hub 188, perhaps providing protection for different age ranges.

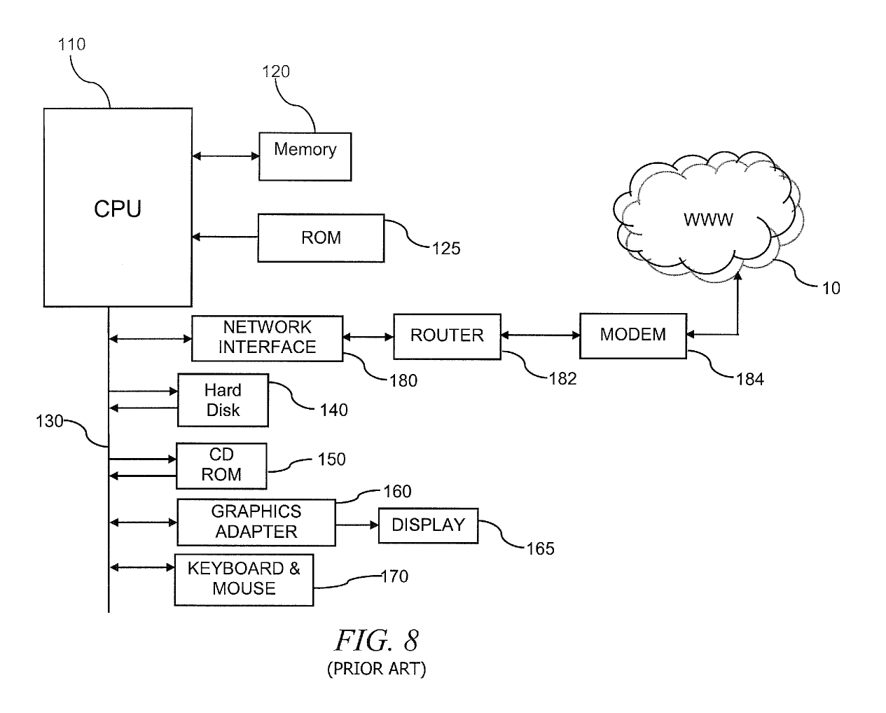

Referring to FIG. 8, a typical computer system of the prior art is shown. A processor 110 is provided to execute stored programs that are generally stored for execution within a memory 120. The processor 110 can be any processor or a group of processors, for example an Intel Pentium-4® CPU or the like. The memory 120 is connected to the processor and can be any memory suitable for connection with the selected processor 110, such as SRAM, DRAM, SDRAM, RDRAM, DDR, DDR-2, etc. Firmware is stored in firmware storage 125 that is connected to the processor 110 and may include initialization software known as BIOS. This initialization software usually operates when power is applied to the system or when the system is reset. In some embodiments, the software is read and executed directly from the firmware storage 125. Alternately, the initialization software is copied into the memory 120 and executed from the memory 120 to improve performance.

Also connected to the processor 110 is a system bus 130 for connecting to peripheral subsystems such as a network interface 180, a hard disk 140, a CDROM 150, a graphics adapter 160 and a keyboard/mouse 170. The graphics adapter 160 receives commands and display information from the system bus 130 and generates a display image that is displayed on the display 165.

In general, the hard disk 140 may be used to store programs, executable code and data persistently, while the CDROM 150 may be used to load said programs, executable code and data from removable media onto the hard disk 140. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. In some embodiments, other devices are connected to the system through the system bus 130 or with other input-output connections. Examples of these devices include printers; mice; graphics tablets; joysticks; and communications adapters such as modems and Ethernet adapters.

The network interface 180 connects the computer-based system to the world-wide-web 10, optionally through a router, bridge or hub 182, which is connected to a modem 184, such as a cable modem or Digital Subscriber Line (DSL) modem. In the preferred embodiment, the modem 184 connects to the World Wide Web 10 through a high-speed link such as a cable broadband connection, a Digital Subscriber Line (DSL) broadband connection, a T1 line or a T3 line.

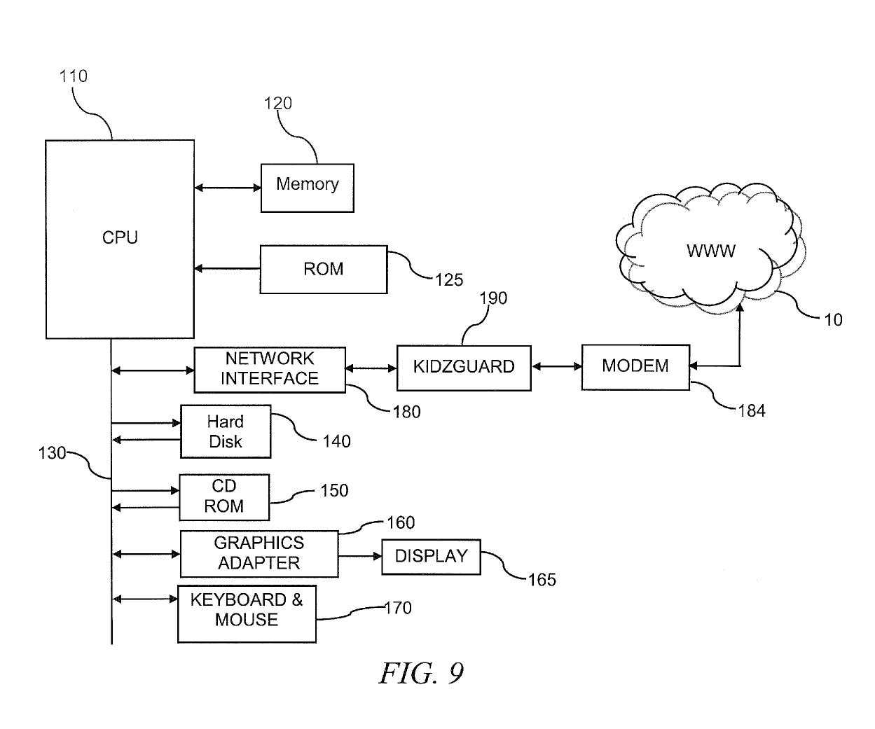

Referring to FIG. 9, a typical terminal device of the present invention is shown. Although the example shows a typical personal computer, various architectures are well known in the industry leading to terminal devices such as personal computers, televisions, personal video recorders, personal digital assistants and phones. Although shown in a simple configuration, having a single processor, many different computer architectures are known that accomplish similar results in a similar fashion and the present invention is not limited in any way to any particular terminal device. The present invention works well utilizing a single processor system as shown in FIG. 9, a multiple processor system where multiple processors share resources such as memory and storage, a multiple server system where several independent servers operate in parallel (perhaps having shared access to a common database) or any combination. In this, a processor 110 is provided to execute stored programs that are generally stored for execution within a memory 120. The processor 110 can be any processor or a group of processors, for example an Intel Pentium-4® CPU or the like. The memory 120 is connected to the processor and can be any memory suitable for connection with the selected processor 110, such as SRAM, DRAM, SDRAM, RDRAM, DDR, DDR-2, etc. Firmware is stored in firmware storage 125 that is connected to the processor 110 and may include initialization software known as BIOS. This initialization software usually operates when power is applied to the system or when the system is reset. In some embodiments, the software is read and executed directly from the firmware storage 125. Alternately, the initialization software is copied into the memory 120 and executed from the memory 120 to improve performance.

Also connected to the processor 110 is a system bus 130 for connecting to peripheral subsystems such as a network interface 180, a hard disk 140, a CDROM 150, a graphics adapter 160 and a keyboard/mouse 170. The graphics adapter 160 receives commands and display information from the system bus 130 and generates a display image that is displayed on the display 165.

In personal computer terminal devices, the hard disk 140 may be used to store programs, executable code and data persistently, while the CDROM 150 may be used to load said programs, executable code and data from removable media onto the hard disk 140. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. In some embodiments, other devices are connected to the system through the system bus 130 or with other input-output connections. Examples of these devices include printers; mice; graphics tablets; joysticks; and communications adapters such as modems and Ethernet adapters.

The network interface 180 connects the terminal device to the world-wide-web 10, through a kidzguard device 190 of the present invention, which is connected to a modem 184. In the prior art, the optional bridge, router or hub (or direct connection between the network interface 180 and the modem 184) provides no pre-configured content protection for the user of the terminal device. Therefore, the offerings of the prior art are often difficult to install, administer, update and use; leading to frustrations that often result in a lack of protection. The kidzguard device 190 of the present invention provides content protection for the terminal device user as described above. In the preferred embodiment, the modem 184 connects to the World Wide Web 10 through a high-speed link such as a cable broadband connection, a Digital Subscriber Line (DSL) broadband connection, a T1 line or a T3 line. In some embodiments, the kidzguard device 190 is integrated with a modem 184.

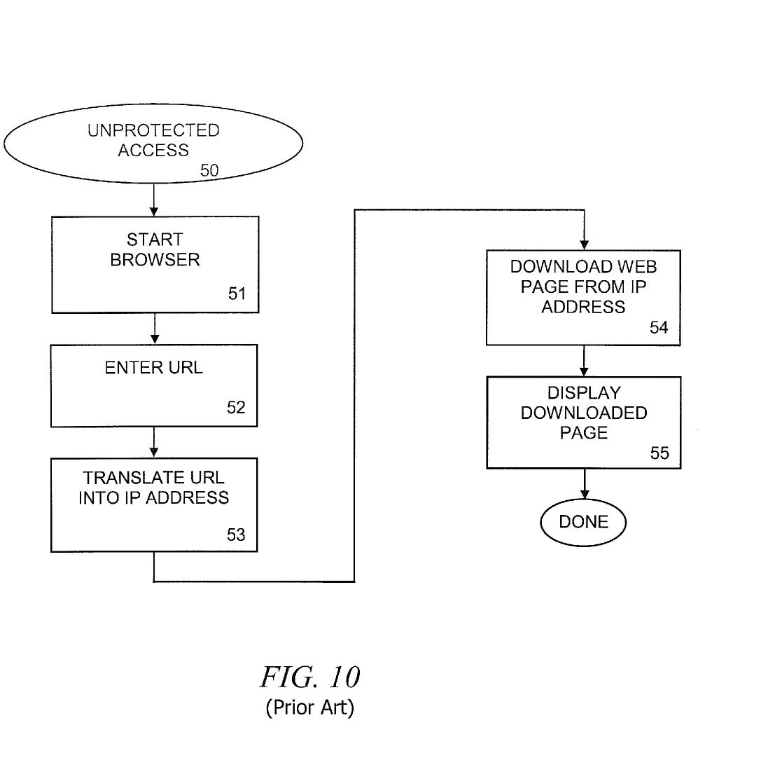

Referring to FIG. 10, a flowchart of unrestricted browsing of the prior art is shown. For simplicity, this description focuses on web browsing but the present invention is not limited to browsing. The present invention protects the child or young adult's terminal device from all types of access to URL-based content from sources including, but not limited to, email addresses (name@web-server.com), Internet Messaging, chatting, peer-to-peer networks and File Transfer Protocol (FTP). This unprotected access 50 typically starts with initiating a web browser 51 such as Netscape Navigator® or Microsoft Internet Explorer®. To access Internet content, a user enters a URL 52 in whatever fashion is supported by their browser including, but not limited to, typing the URL, selecting a hot link, using history or selecting a favorite. The URL is then converted into an IP address 53, normally by a Domain Name Service (DNS). Next, the browser addresses the web page at the IP address and downloads its contents 54 without respect to any parental ratings, etc. Finally, the contents of the web page are displayed 55 on the user's display monitor.

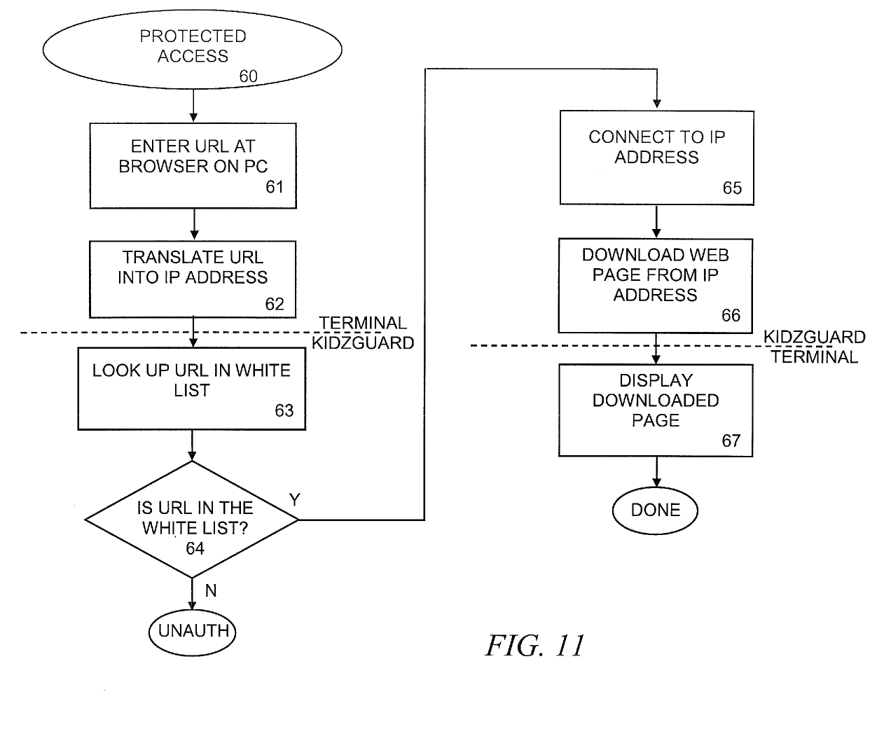

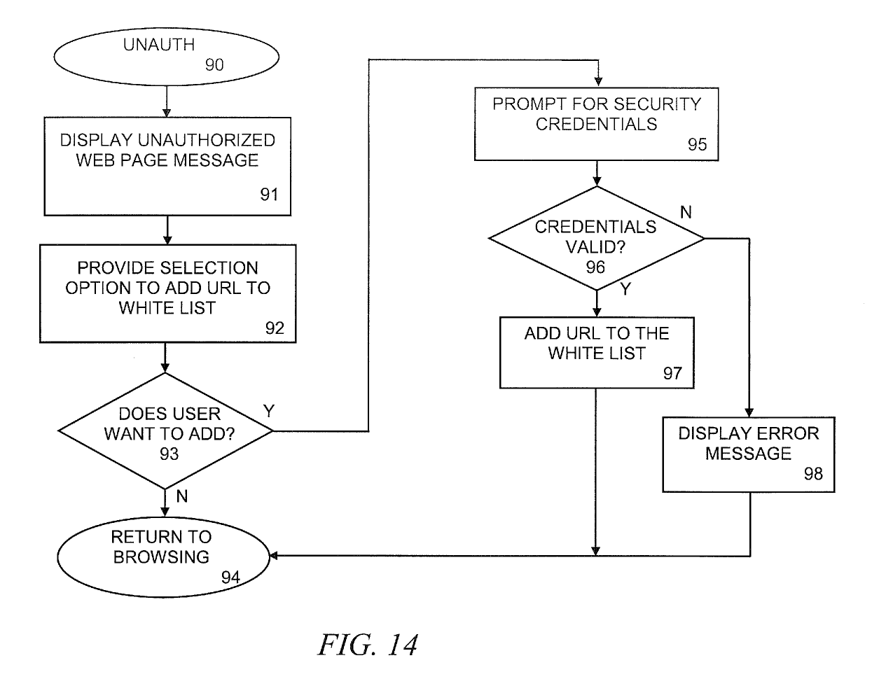

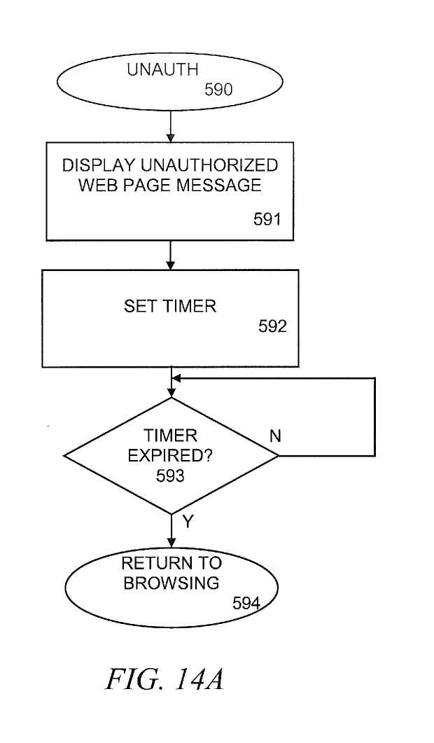

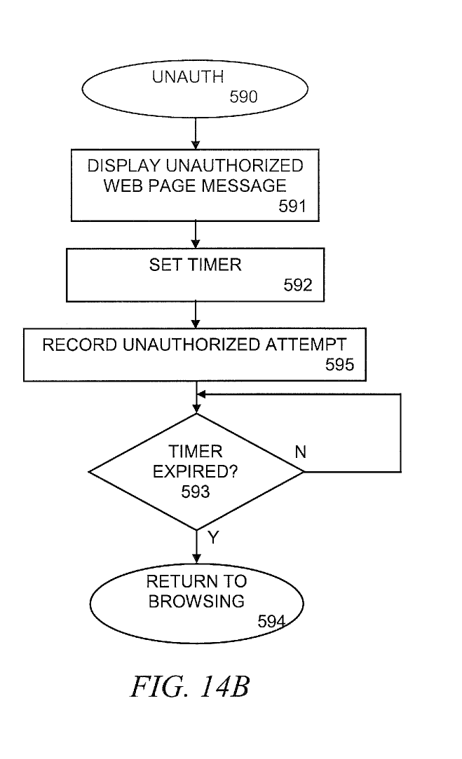

Referring to FIG. 11, a flowchart of protected browsing of a first embodiment of the present invention using a whitelist is shown. There are many known ways to determine appropriate content including, but not limited to, a white list of approved websites, a blacklist of restricted websites, a URL naming convention (e.g., xxx), keyword recognition in the URL, keyword recognition in the content of the web page, pattern recognition in the content of the web page, color map histogram analysis of the content of the web page (excessive flesh tones), etc. The present invention is not limited to any particular method of content identification and classification. The following demonstrates the operation of three of the known methods, including, whitelists, blacklists and restricted keywords in the web page content, although any or all known methods can be used in any combination. Continuing with FIG. 11, protected access 60 using whitelists will be described. As in the prior art, the user enters a URL at their terminal device's browser 61 in order to access web content. The URL is then translated into an IP address 62, typically using a domain name service (DNS). Within the kidzguard, the URL is looked up in a whitelist 63. The whitelist is a list of URLs of web sites that are approved for the class of child/young-adult being protected by a given kidzguard 190. For example, a whitelist has included the URLs: www.google.com and www.disney.com but does not include www.cnn.com. In this example, the child can access www.google.com and www.disney.com but cannot access www.cnn.com. The whitelist can be stored in any list or database format known including lists, sorted lists, binary lists, hash lists, hierarchical databases, relational databases, etc. The flow continues with determining if the desired URL is in the whitelist 64. If it isn't, flow proceeds with an unauthorized error path (see FIG. 14). If it is, a connection is established to the IP address 65 and the web page is downloaded 66 by the kidzguard and displayed on the user's terminal device 67. In alternate embodiments, the whitelist includes IP addresses of the allowed websites and, instead of looking up the URL in the whitelist 64; the IP address is looked up in the whitelist.

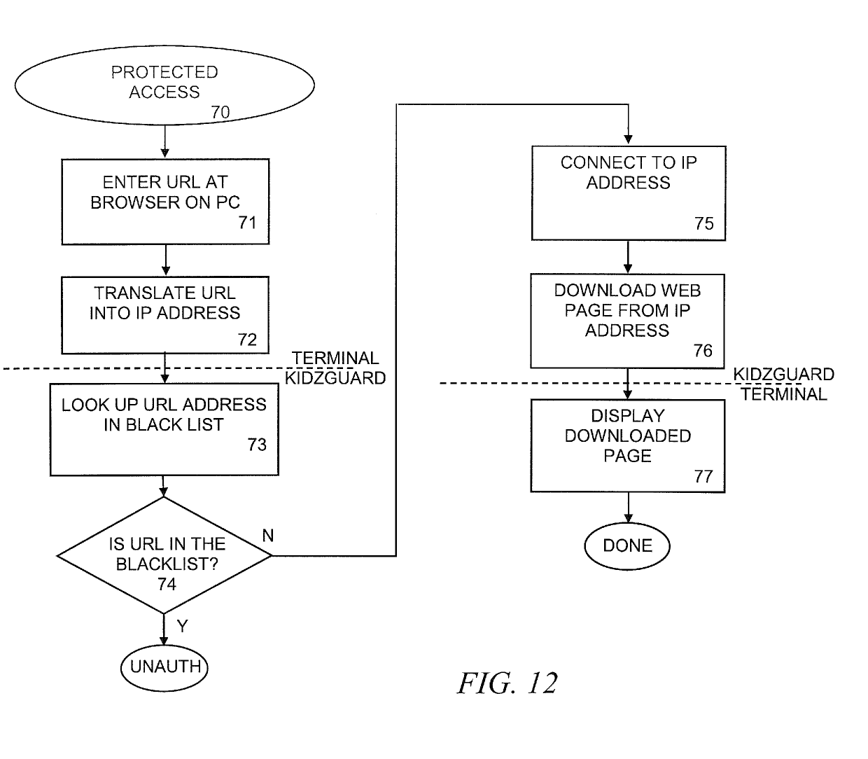

Referring to FIG. 12, a flowchart of protected browsing 70 of the present invention using a blacklist is shown. As in FIG. 11, the user enters a URL at their terminal device browser 71 (or URL in any other connection-oriented software program) in order to access web content. The URL is translated into an IP address 72 (as previously described) and the URL is looked up in a blacklist 73 within the kidzguard device 190. The blacklist is a list of URLs of web sites that are not suitable for the class of child/young-adult being protected by a given kidzguard 190. For example, a blacklist includes a URL for www.cnn.com, but does not include www.google.com and www.disney.com. In this example, the child can access www.google.com and www.disney.com because they are not in the blacklist but cannot access www.cnn.com because it is in the blacklist. The blacklist can be stored in any list or database format known including lists, sorted lists, binary lists, hash lists, hierarchical databases, relational databases, etc. The flow continues with determining if the URL is in the blacklist 74. If it is, flow proceeds with an unauthorized error path (see FIG. 14). If it isn't, a connection is made to the IP address of the desired page 75 and the web page is downloaded by the kidzguard 76 and displayed at the user's terminal device 77. In alternate embodiments, the blacklist includes IP addresses of the allowed websites instead of URLs and, instead of looking up the URL in the blacklist 74, the IP address is looked up in the blacklist during the DNS translation process.

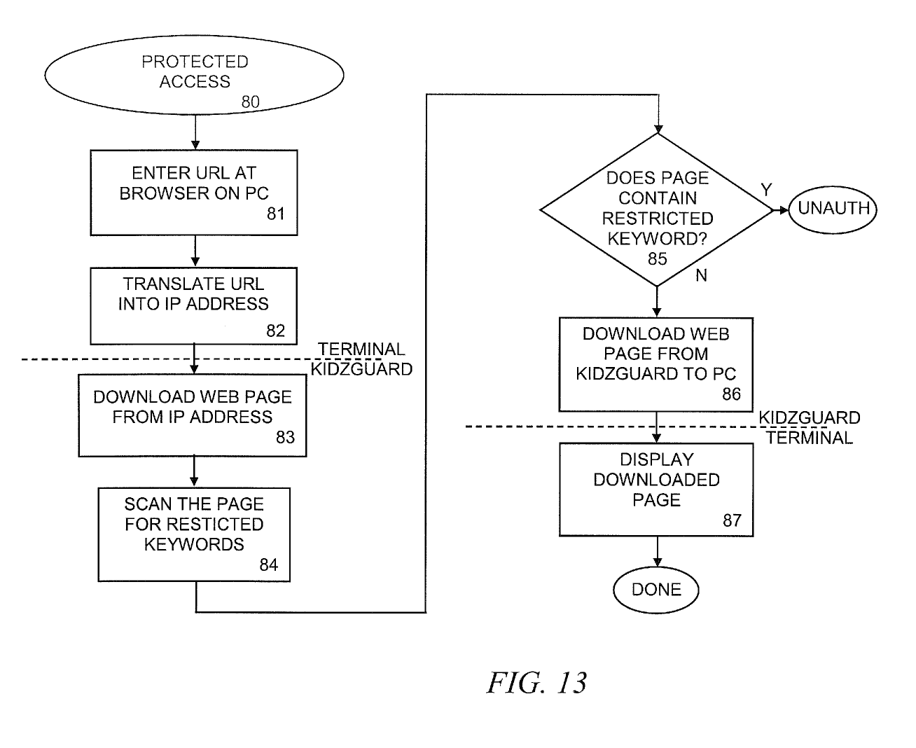

Referring to FIG. 13, a flowchart of protected browsing of a first embodiment of the present invention using a content keyword blacklist 80 is shown. As in FIGS. 11 and 12, the user enters a URL at their terminal device's browser 81 in order to access web content. The URL is translated into an IP address at their terminal device 82 (as previously described) and at least part of the web page at the IP address is downloaded to the kidzguard 83, preferably storing such in local memory. The downloaded content is scanned for restricted keywords 84 determined not suitable for the class of child/young-adult being protected by the given kidzguard 190. For example, a web page having the word “sex” or “nudity” is restricted for most age ranges protected by the kidzguard device 190. The restricted keyword list is stored in any list or database format known including lists, sorted lists, binary lists, hash lists, hierarchical databases, relational databases, etc. The flow continues with determining if any word from the web page is a restricted keyword from the list 85. If there is, flow proceeds with an unauthorized error path (see FIG. 14). If no restricted keyword is present, the web page is downloaded from the kidzguard 190 to the user's terminal device 86 and displayed at the user's terminal device 87.

Referring to FIG. 14, a continuation of FIGS. 11, 12 and 13, a flowchart of protected browsing of a first embodiment of the present invention is shown. There are many actions that are possible when a user protected by a kidzguard device 190 attempts to access an unapproved web site. Although not limited to any particular action, the simplest action is to present a warning page and allow the user to continue browsing by entering a new URL. In alternate embodiments, the user is inconvenienced in various ways. For example, they are prevented from using the Internet for a period of time or they are required to have their parents authorize them before they continue or both. In some embodiments, the severity of the inconvenience is dependent upon the severity of the child's or young adult's action. For example, attempting to view a web site that has mild profanity results in a 10 second lock out while attempting to view a web site at a URL that ends with “xxx” results in a lock out that has to be reset by a parent. In the example of FIG. 14, the user has attempted access to an unauthorized web page 90. A local page is displayed 91 telling the user that they are not allowed to access that URL along with a selection button to add that URL to the whitelist 92. They can decide to add the URL or not 92. If they select not to add the URL to the whitelist 93, they are allowed to go back to browsing 94. If they select to add the URL to the whitelist, they must enter authentication information 95 such as a user name and password (typically performed by the parent). The credentials are validated 96 and if valid by the kidzguard 190, added to the whitelist 97. Otherwise, an error message is displayed 98. In another embodiment, a lockout timer inconveniences the user. They are prevented from using the Internet for a period of time as shown in the example of FIG. 14A. In this example, the user has attempted access to an unauthorized web page 590. A local page is displayed 591 telling the user that they are not allowed to access that URL. A timer is set 592 and the user cannot continue browsing until the timer expires 593, at which time they are allowed to go back to browsing 594. In FIG. 14B, after they are prevented from using the Internet for a period of time a record is saved 595 for distribution to an adult or guardian. In this example, the user has attempted access to an unauthorized web page 590. A local page is displayed 591 telling the user that they are not allowed to access that URL. In this example, a timer is set 592, a record of the unauthorized attempt is saved 595 and the user cannot continue browsing until the timer expires 593, at which time they are allowed to go back to browsing 594. In other embodiments, return to browsing is immediate. In some embodiments, the record of the unauthorized attempt is sent immediately to the adult or guardian by methods known in the industry including email, instant messaging, text messaging, paging and the like. In other embodiments, multiple records of the unauthorized attempt are saved and sent later to the adult or guardian by methods known in the industry including email, instant messaging, text messaging, paging and the like.

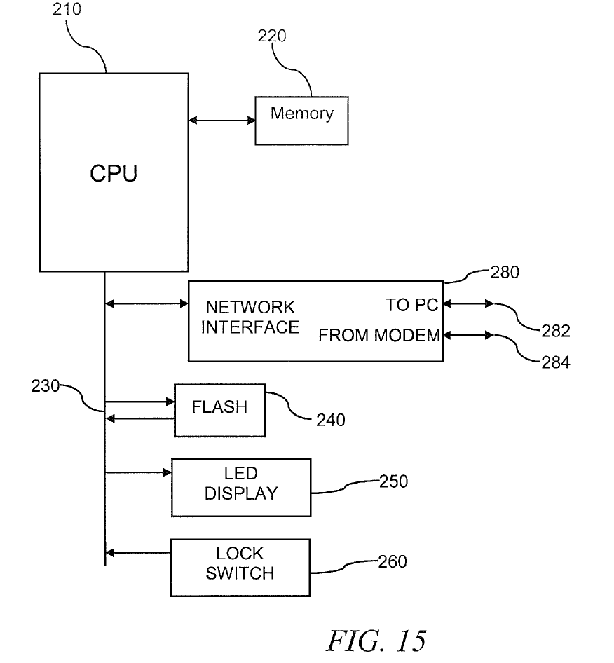

Referring to FIG. 15, a typical hardware platform of a Kidzguard of the present invention is shown. For cost and space reasons, the preferred platform utilizes a single processor or microcontroller 210, although many different computer architectures are known that accomplish similar results in a similar fashion and the present invention is not limited in any way to any particular architecture. In this exemplary architecture, the processor 210 is provided to execute stored programs that are generally stored for execution within a local memory 220. The processor 210 can be any processor, for example an Intel 80C51 CPU or the like. The memory 220 is connected to the processor and can be any memory suitable for connection with the selected processor 210, such as SRAM, DRAM, SDRAM, RDRAM, DDR, DDR-2, etc. In some embodiments, the memory 220 is imbedded within the processor 210. Firmware is stored in Flash storage 240 that is connected to the processor 210 through a system bus 230. Also connected to the processor 210 through the system bus 230 is a network interface 280. In some embodiments one or more Light Emitting Diodes (LEDs) 250 and an optional lock switch 260 are also interfaced to the processor 210 through the system bus 230.

The network interface 280 has at connection 284 for interfacing the kidzguard device 190 to the world-wide-web 10 through a modem (not shown in FIG. 15) and one or more connections 282 for interfacing the kidzguard device 190 to one or more protected computers. In some embodiments, there are one or more additional connections for interfacing the kidzguard device 190 to one or more unprotected computers. The kidzguard device 190 of the present invention provides content protection for the computer system user as described above.

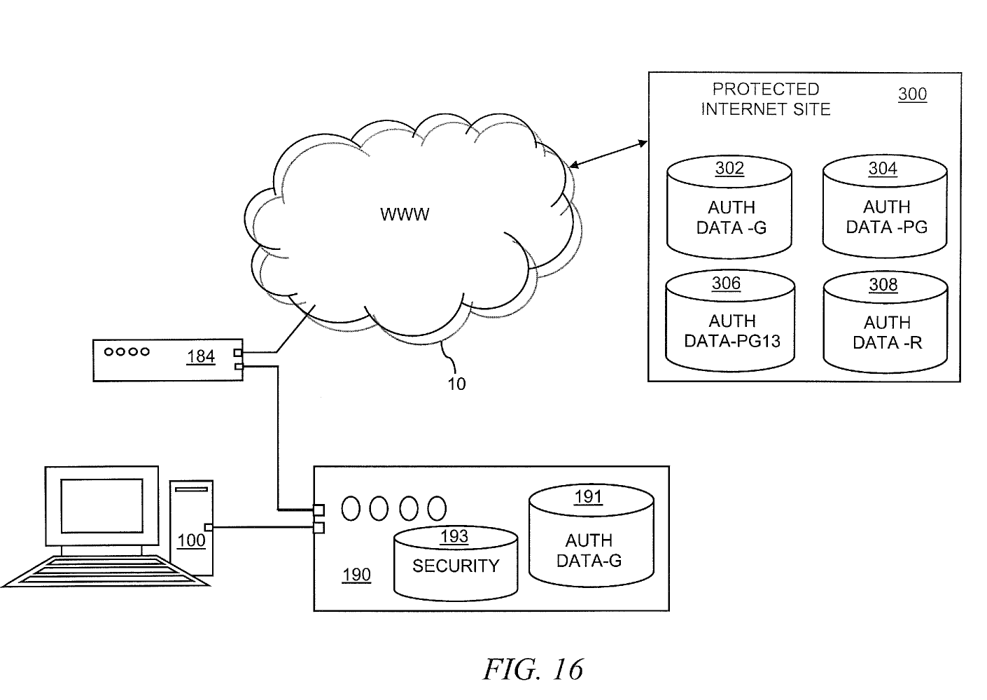

Referring to FIG. 16, a schematic view of a first embodiment of the Kidzguard of the present invention is shown. In this embodiment, the kidzguard 190 has authorization data 191, typically stored in the flash memory 240, although in some embodiments, the authorization data 191 is stored on a hard disk drive (not shown). Also, in some embodiments, security data 193 is also stored in the flash memory 240. In this example, the authorization data 191 is configured for a kidzguard 190 that restricts access to G rated content. As discussed previously, a whitelist, blacklist, URL blacklist or other methods of determination are used to determine if a given web page is suitable for the user. For simplicity, the described example will use a whitelist. In this example, the authorization data 191 is pre-populated with a list of allowable web sites (IP addresses) for a G-rated user. In alternate embodiments, the kidzguard 190 is programmed with its rating classification, in this case G, and once connected to the Internet 10 through a modem 184, downloads an up-to-date authorization list 191 from a protected Internet site 300. The pre-populated classification (e.g., G) is preferably stored within the security data 193. As shown, the protected Internet site 300 has authorization data for four different classifications, G 302, PG 304, PG-13 306 and R 308, though in other embodiments, authorization is categorized into age ranges, religions or other categories.

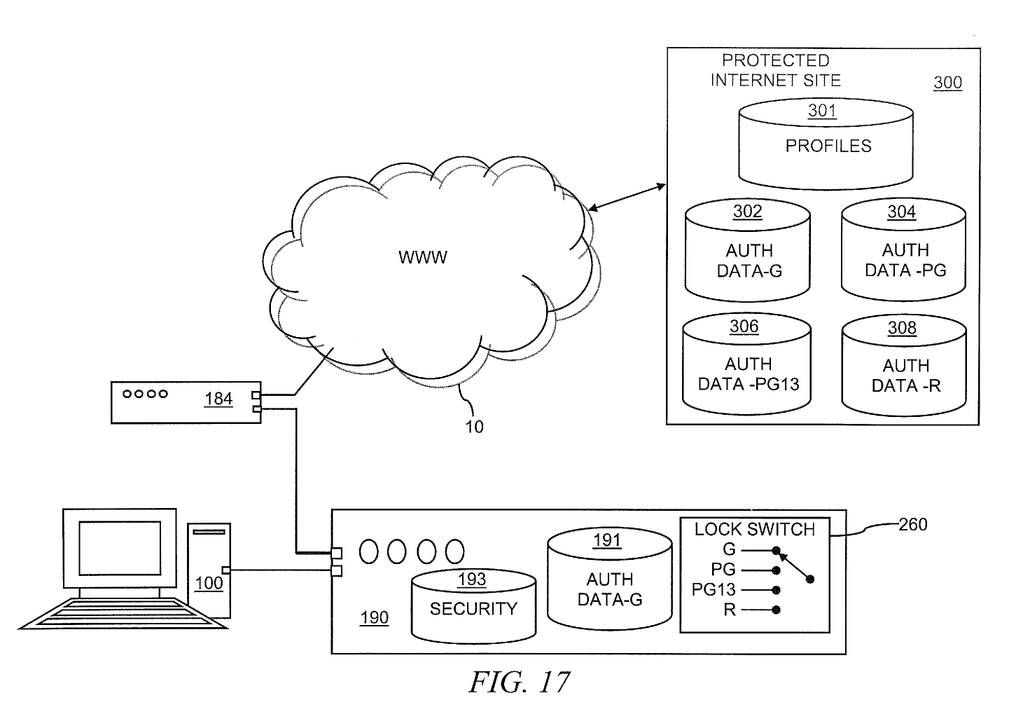

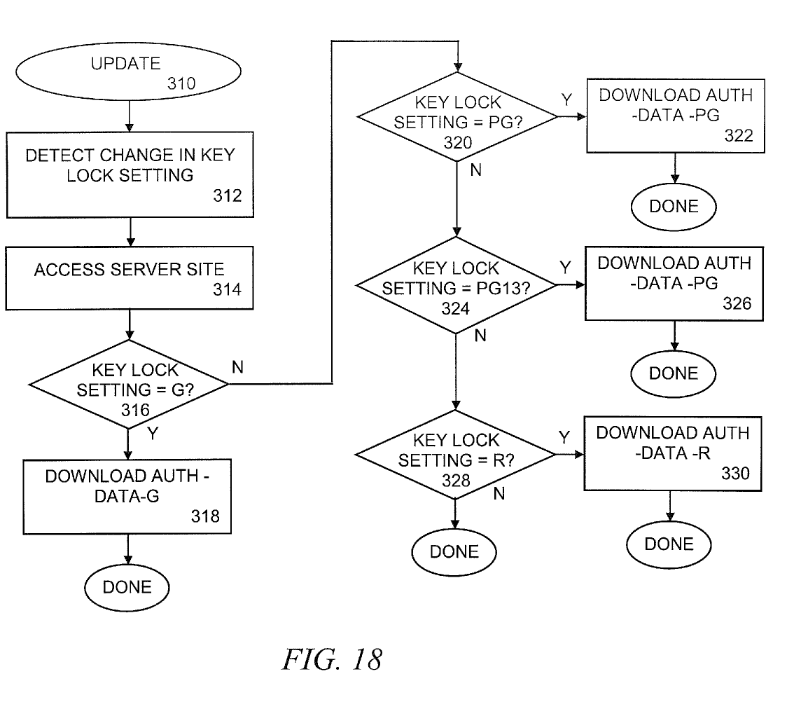

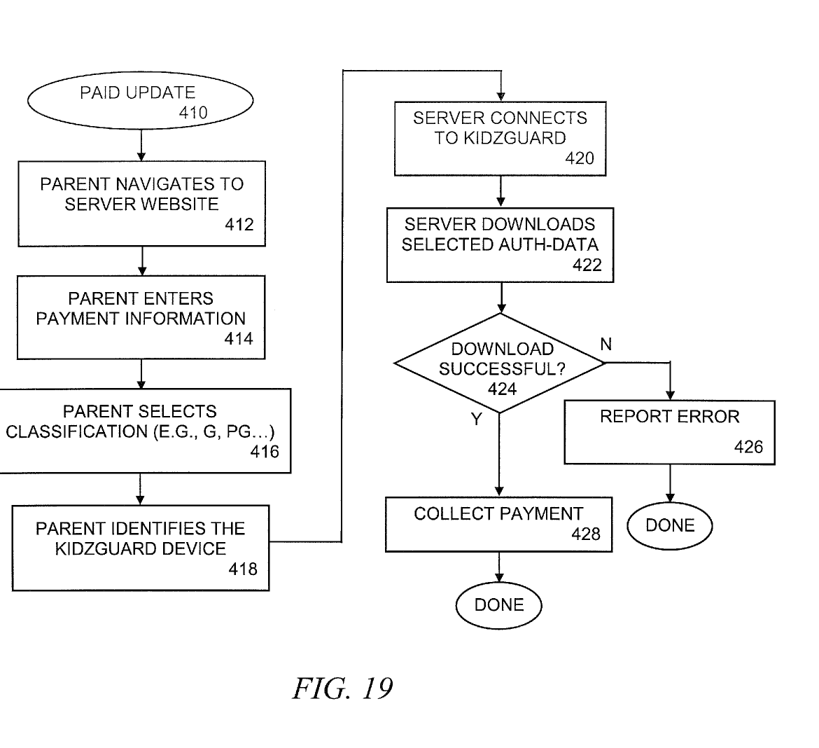

Referring to FIG. 17, a schematic view of a second embodiment of the Kidzguard of the present invention is shown. This example is similar to that shown in FIG. 16 with the addition of a lock switch 260 on the kidzguard 190 and a profile 301 on the protected Internet site 300. In one embodiment, the kidzguard device 190 is programmed with the ability to be reconfigured by a parent having a key. The parent inserts the key into the lock switch 260 and changes the configuration. The operation of this is described in the flowchart of FIG. 18. In another embodiment, the parent requests an upgrade of their kidzguard device 190, preferably through the Internet or by a phone call. The parent is authorized and identifies their kidzguard device 190 by, preferably, serial number. As will be shown in FIG. 19, the information provided is verified against profile information 301 and, if valid, a new authorization list 302/304/306/308 is downloaded from the protected Internet site 300 to the kidzguard 190.

Referring to FIG. 18, a flowchart of a first method of configuring of all embodiments of the present invention is shown. In some embodiments of the kidzguard device 190, the kidzguard device 190 is preset to a particular classification (e.g., G) and cannot be changed. In this embodiment, the classification is changeable. The kidzguard device 190 has a hardware switch 240 that permits it to be reconfigured to a different classification. With such, a parent can purchase a single kidzguard device 190 when their child is young, and then change its operation as the child progresses. As the child progresses, the parent uses a key (not shown) or other secure method to change the classification of the kidzguard 190. The key or other method changes the setting of a hardware switch 260. The update 310 of the kidzguard 190 starts with detecting a change of the key lock switch 312. In response, the kidzguard device 190 connects to the protected Internet site 314. If the new setting of the key lock switch is G 316, the authorization list for the G classification is downloaded to the kidzguard device 318. If the new setting of the key lock switch is PG 320, the authorization list for the PG classification is downloaded to the kidzguard device 322. If the new setting of the key lock switch is PG13 324, the authorization list for the PG13 classification is downloaded to the kidzguard device 326. Finally, if the new setting of the key lock switch is R 328, the authorization list for the R classification is downloaded to the kidzguard device 330. Once the new authorization list is downloaded, the kidzguard device 190 protects for the new classification. As previously discussed, different classifications are possible, including age, skill levels, etc.

Referring to FIG. 19, a flowchart of a second method of configuring of the present invention is shown. Another way to update a kidzguard device 190 is through a paid update 410. In this method, the parent accesses a protected website 412 and enters payment information 414, selects the desired classification/rating 416 and identifies their kidzguard device 418, preferably by serial number. Alternately, the kidzguard device 190 is identified by relating the parent's name, credit card information, or other identification information to its serial number. The translation information and IP address of the specific kidzguard device is stored on the protected web site in the profile information 301. Once verified, the kidzguard protected website 300 makes an Internet connection to the identified kidzguard device 420. Next, the authorization data 302/304/306/308 for the requested classification is downloaded to the identified kidzguard device 422. If the download finishes successfully 424, the payment is collected 428. If unsuccessful, an error is reported 426 and the payment is not collected.

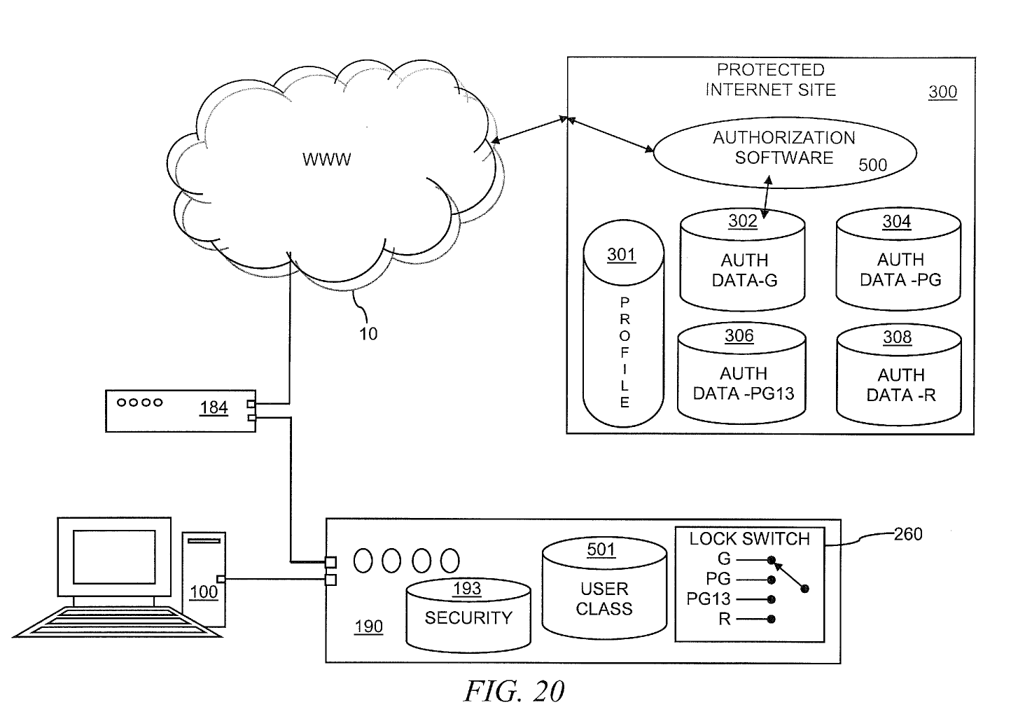

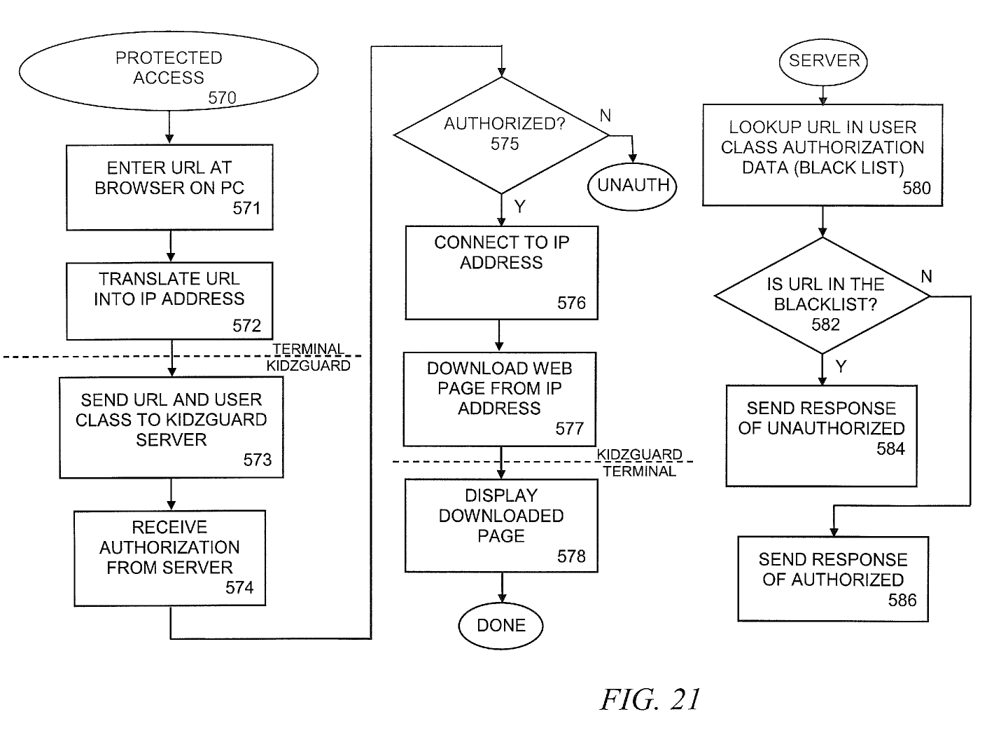

Referring to FIG. 20, a schematic view of a third embodiment of the Kidzguard of the present invention is shown. This example is similar to that shown in FIG. 17 except that the authorization is performed at the Kidzguard server 300 instead of at the Kidzguard device 190. In one embodiment, the kidzguard device 190 is programmed with the ability to be reconfigured by a parent having a key. The parent inserts the key into the lock switch 260 and changes the configuration. The operation of this is described in the flowchart of FIG. 18. In another embodiment, the parent requests an upgrade of their kidzguard device 190, preferably through the Internet or by a phone call. The parent is authorized and identifies their kidzguard device 190 by, preferably, serial number. As shown in FIG. 19, the information provided is verified against profile information 301 and, if valid, a new user class 501 is set in the kidzguard 190. As will be shown in the description of FIG. 21, the user class is passed from the Kidzguard device 190 to the Kidzguard server 300 for authorization at the Kidzguard server 300 and, an authorization or un-authorization response is sent back to the kidzguard device 190.

Referring to FIG. 21, a flowchart of protected browsing 570 of the present invention using a remote content check is described. As in FIG. 11, the user enters a URL at their terminal device browser 571 (or URL in any other connection-oriented software program) in order to access web content. The URL is translated into an IP address 572 (as previously described) and the URL along with the user class 191 is sent 573 to the kidzguard server 300. At the kidzguard server 300, the IP address is looked up in the authorization list associated with the user class 580. As an example, the authorization list is a blacklist of URLs of web sites that are not suitable for the user class being protected by a given kidzguard 190. For example, a blacklist includes a URL for www.cnn.com, but does not include www.google.com and www.disney.com. In this example, the child can access www.google.com and www.disney.com because they are not in the blacklist but cannot access www.cnn.com because it is in the blacklist. The blacklist can be stored on the server in any list or database format known including lists, sorted lists, binary lists, hash lists, hierarchical databases, relational databases, etc. In other embodiments, other forms of authorization checking are performed by the server, including the use of whitelists, forbidden keyword lists and image/voice analysis algorithms and/or heuristics. The flow continues with the server 300 looking up the blacklist in the authorization data related to the class of user 580 and determining if the URL is in the blacklist 582. If it is on the blacklist, the server sends back a response indicating the URL is un-authorized 584. The kidzguard device 190 receives the authorization response 574 and since it is un-authorized 575, the unauthorized error path is taken (see FIG. 14). If it isn't on the blacklist (authorized), the server sends back a response indicating the URL is authorized 586. The kidzguard device 190 receives the authorization response 574 and since it is authorized 575, a connection is made to the IP address of the desired page 576 and the web page is downloaded by the kidzguard 577 and displayed at the user's terminal device 578. In alternate embodiments, the blacklist includes IP addresses of the allowed websites instead of URLs and, instead of looking up the URL in the blacklist 580, the IP address is looked up in the blacklist during the DNS translation process.

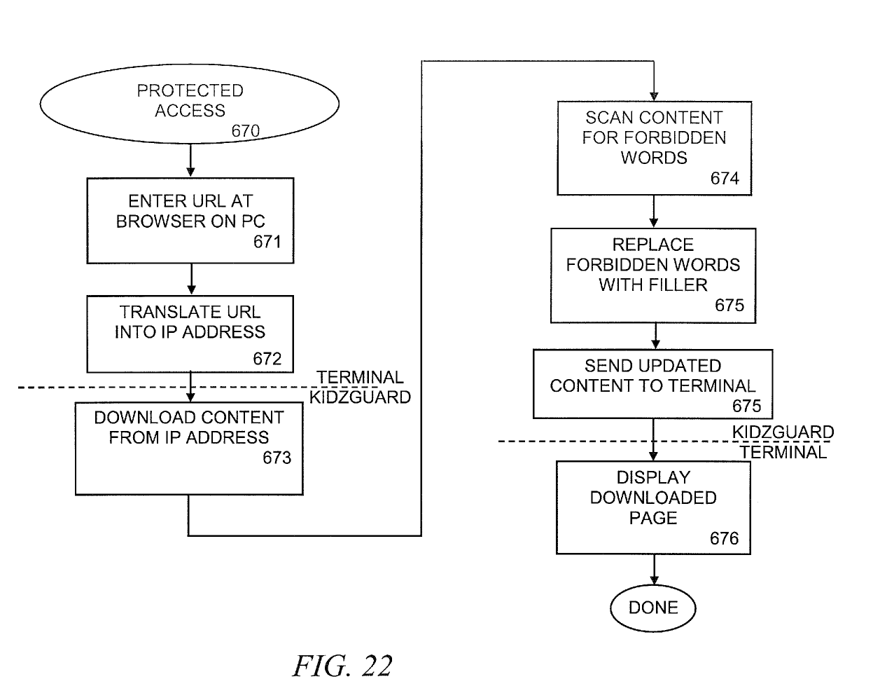

Referring to FIG. 22, a flowchart of protected browsing 670 of the present invention using analysis of content is shown. As in FIG. 11, the user enters a URL at their terminal device browser 671 (or URL in any other connection-oriented software program) in order to access web content. The URL is translated into an IP address 672 (as previously described). At the kidzguard device 190, a connection is made to the IP address of the desired content 673 and the content is downloaded. The content is then scanned for words, phrases, audio words or images that are forbidden 674. In some embodiments, a list of forbidden words or phrases is used. The list of forbidden words or phrases can be stored in any list or database format known including lists, sorted lists, binary lists, hash lists, hierarchical databases, relational databases, etc. In some embodiments, any word or phrase found from the forbidden list is replaced with filler such as “****” or “!@#$” 675 and the updated content with the filler instead of the forbidden words is transferred to the terminal device 675 and displayed at the terminal device 676. In alternate embodiments, algorithms or heuristics are used to find forbidden words, audio phrases, phrases or images. An exemplary heuristic would be plotting the color map of an image in a histogram and determining the percentage of colors relating to flesh tones. If the percentage is higher than an acceptable value, access to the image is denied.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A pre-configured internet protection device comprising:
a processor housed within the internet protection device;
a first network interface for connecting to a network, the first network interface operably coupled to the processor;
a second network interface for connecting to at least one terminal device, the second network interface operably coupled to the processor; and
a means for selectively preventing access from the at least one terminal device to at least one web service through the first network interface, the means for preventing access adapted to execute on the processor and the at least one web service specified by a unified resource locator, whereas the means for selectively preventing access is pre-configured for a predetermined class of user.

2. The internet protection device of claim 1, wherein the means for selectively preventing access includes an authorization list stored locally to the pre-configured internet protection device.

3. The internet protection device of claim 1, wherein the means for selectively preventing access includes an algorithm that executes locally to the pre-configured internet protection device.

4. The internet protection device of claim 3, wherein the algorithm consults a web server.

5. The internet protection device of claim 2, wherein the authorization list includes a whitelist, whereas access is allowed to web services included in the whitelist.

6. The internet protection device of claim 2, wherein the authorization list includes a URL keyword list, whereas access is prevented to web services having a keyword from the URL keyword list in the universal resource locator.

7. The internet protection device of claim 2, wherein the authorization list is pre-populated with protection entries for the predetermined class of user.

8. The internet protection device of claim 1, wherein the predetermined class of user is categorized by a rating system and the rating system includes ratings selected from the group consisting of G-rated, PG-rated, PG13-rated and R-rated.

9. The internet protection device of claim 1, wherein the predetermined class of user is based upon age ranges selected from the group consisting of 0 to 6 years old, 7 to 12 years old and 13 to 18 years old.

10. The internet protection device of claim 1, wherein the at least one terminal device is selected from the group consisting of a personal computer, a personal digital assistant, a cellular phone and a personal music player.

11. A pre-configured internet protection device comprising:
a processor housed within the pre-configured internet protection device;
a means for connecting the processor to a network;
a means for connecting the processor to a terminal device; and
a means for selectively preventing access from the terminal device to at least one web service, the means for selectively preventing access adapted to execute on the processor and the at least one web service specified by a unified resource locator, whereas the means for selectively preventing access is pre-configured for a predetermined class of user.

12. The internet protection device of claim 11, wherein the means for selectively preventing access includes an authorization list stored locally to the pre-configured internet protection device.

13. The internet protection device of claim 11, wherein the means for selectively preventing access includes an algorithm that executes locally to the pre-configured internet protection device.

14. The internet protection device of claim 12, wherein the authorization list includes a whitelist, whereas access is allowed to web services included in the whitelist.

15. The internet protection device of claim 12, wherein the authorization list includes a URL keyword list, whereas access is prevented to web services having a keyword from the URL keyword list in the universal resource locator.

16. The internet protection device of claim 12, wherein the authorization list is pre-populated with protection entries for the predetermined class of user.

17. The internet protection device of claim 11, wherein the predetermined class of user is categorized by a rating system and the rating system includes ratings selected from the group consisting of G-rated, PG-rated, PG13-rated and R-rated.

18. The internet protection device of claim 11, wherein the predetermined class of user is based upon age ranges selected from the group consisting of 0 to 6 years old, 7 to 12 years old and 13 to 18 years old.

19. The internet protection device of claim 11, wherein the terminal device is selected from the group consisting of a personal computer, a personal digital assistant, a cellular phone and a personal music player.

20. A method for protecting a class of users of a terminal device from undesirable content from an internet, the method comprising:
providing an internet protection device comprising:
a processor;
a means for connecting to the internet through a modem, the means for connecting to the internet operably coupled to the processor;
a means for connecting to the terminal device, the means for connecting to the terminal device operably coupled to the processor;
a means for selectively preventing access from the terminal device to at least one web service, the means for selectively preventing access adapted to execute on the processor, whereas the means for selectively preventing access is pre-configured for the class of user;
specifying a unified resource locator of a target web service at the terminal device by a user;
determining if the target web service has undesirable content by the means for selectively preventing access;
if the target web service has undesirable content, selectively preventing access to the web service by the means for preventing access; and
if the target web service is absent of undesirable content, allowing access to the web service by the means for selectively preventing access.

21. The method for protecting a class of users of claim 20, wherein the means for selectively preventing access utilizes a whitelist, whereas access is allowed to a set of web services included in the whitelist.

22. The method for protecting a class of users of claim 20, wherein the means for selectively preventing access utilizes an algorithm executing on the processor.

23. The method for protecting a class of users of claim 20, wherein the class of user is categorized by a rating system and the rating system includes ratings selected from the group consisting of G-rated, PG-rated, PG13-rated and R-rated.

24. The method for protecting a class of users of claim 20, wherein the class of user is based upon age ranges selected from the group consisting of 0 to 6 years old, 7 to 12 years old and 13 to 18 years old.

25. The method for protecting a class of users of claim 20, further comprising the steps of:
authenticating a parent after preventing access to the web service by the means for selectively preventing access; and
updating the means for selectively preventing access, thereby allowing future access the target web service.

26. The method for protecting a class of users of claim 20, further comprising the steps of:
displaying a warning message at the terminal device after preventing access to the target web service by the means for selectively preventing access; and
preventing access from the terminal device to the internet for a predetermined time period.

27. A computer implemented method for protecting a class of user of a terminal device from undesirable content from a network, the computer implemented method operating on a protection device external to the terminal device, the protection device comprising:
a processor;
a means for connecting to the network, the means for connecting to a network operably coupled to the processor;
a means for connecting to the terminal device, the means for connecting to the terminal device operably coupled to the processor;
the computer implemented method executing on the processor and the computer implemented method comprising:
receiving a target unified resource locator from the terminal device;
determining if the target unified resource locator is associated with a web service having desirable content for the class of user;
if the target unified resource locator is associated with undesirable content, preventing access from the terminal device to the web service; and
if the target unified resource locator is associated with the desirable content, allowing access from the terminal device to the web service.

28. The computer implemented method for protecting a class of users of claim 27, wherein the step of determining includes checking an authorization list to determine if the web service is associated with the desirable content.

29. The computer implemented method for protecting a class of users of claim 28, wherein the authorization list includes a whitelist, whereas access is allowed to a set of web services included in the whitelist.

30. The computer implemented method for protecting a class of users of claim 28, wherein the authorization list is pre-populated with entries for a predetermined class of user.

31. The computer implemented method for protecting a class of users of claim 27, wherein the predetermined class of user is categorized by a rating system and the rating system includes ratings selected from the group consisting of G-rated, PG-rated, PG13-rated and R-rated.

32. The computer implemented method for protecting a class of users of claim 27, wherein the predetermined class of user is based upon age ranges selected from the group consisting of 0 to 6 years old, 7 to 12 years old and 13 to 18 years old.

33. The computer implemented method for protecting a class of users of claim 27, wherein the step of determining includes an algorithm executing on the processor that determines if the web service is associated with the desirable content.

34. The computer implemented method for protecting a class of users of claim 33, wherein the algorithm consults with a web server to determine if the web service is associated with the desirable content.

35. The computer implemented method for protecting a class of users of claim 27, further comprising after the step of selectively preventing access to the web service, the steps of:
authenticating an administrator; and
adding the target unified resource locator as an allowed web service in the authorization list.

36. The computer implemented method for protecting a class of users of claim 27, further comprising after the step of preventing access to the web service, the steps of:
sending a response page containing a warning message to the terminal device; and
preventing access from the terminal device to the internet for a predetermined time period.

37. The computer implemented method for protecting a class of users of claim 27, further comprising after the step of preventing access to the web service, the steps of:
sending a warning message to an administrator.
